(19) United States
(12) Patent Application Publication
(10) Pub. No.: US 2010/0207047 A1
(43) Pub. Date: Aug. 19, 2010

(54) GAS SHUTOFF VALVE

(75) Inventors: Hiroaki SUZUKI, Nagoya-shi (JP); Munetoshi KUROYANAGI, Nukata-gun (JP); Toshikatsu KUBO, Okazaki-shi (JP)

Correspondence Address: OLIFF & BERRIDGE, PLC, P.O. BOX 320850, ALEXANDRIA, VA, 22320-4850, US

(73) Assignee: JTEKT CORPORATION, OSAKA (JP)

(21) Appl. No.: 12/706,316

(22) Filed: Feb. 16, 2010

(30) Foreign Application Priority Data
Feb. 17, 2009 (JP) 2009-034297

(51) Int. Cl. F16K 1/00

(52) U.S. Cl. 251/318

(57) ABSTRACT

A restriction plate is arranged at a position that is apart from a female screw portion by a distance shorter than a length of a portion of a male screw portion of an operation screw, which is screwed into a female screw portion of a plug body housing, along the axial direction in the valve-closed state. Therefore, when the operation screw is unscrewed, the operation screw contacts the restriction plate before the operation screw is completely unscrewed from the plug body housing.

### INCORPORATION BY REFERENCE

The disclosure of Japanese Patent Application No. 2009-034297 filed on Feb. 17, 2009 including the specification, drawings and abstract is incorporated herein by reference in its entirety.

### BACKGROUND OF THE INVENTION

1. Field of the Invention

The invention relates generally to a gas shutoff valve, and more specifically to a high-pressure hydrogen gas shutoff valve.

2. Description of the Related Art

In a passage that provides communication between the inside and the outside of a gas tank that stores high-pressure hydrogen gas, there is provided a shutoff valve that shuts off gas flow within the passage. This type of shutoff valve is described in, for example, Japanese Patent Application Publication No. 2006-144841 (JP-A-2006-144841).

This shutoff valve includes a main valve element that contacts and move away from a valve seat that is formed at a bottom portion of a valve chest, and an operation screw that is screwed into a female screw portion that is formed at an opening portion of the valve chest. The main valve element is biased toward the operation screw by an elastic force of a valve spring so that the main valve element and the operation screw always contact each other. When the operation screw is moved in such a direction that the operation screw is screwed into the female screw portion by a rotating operation of the operation screw (hereinafter, referred to as “screwing direction), the main valve element is pushed by the operation screw so that the main valve element moves together with the operation screw in the screwing direction against the elastic force of the valve spring and contacts the valve seat. On the other hand, when the operation screw is moved in such a direction that the operation screw is unscrewed from the female screw portion by a rotating operation (hereinafter, referred to as “unscrewing direction”), the main valve element is pushed by the valve spring and moves together with the operation screw in the unscrewing direction, so that the main valve element moves away from the valve seat.

In this type of shutoff valve, when the main valve element and the operation screw are removed, these members may be ejected by an internal pressure in the valve chest. A structure for preventing ejection of these members is described in, for example, Japanese Patent Application Publication No. 09-222926 (JP-A-09-222926). A shutoff valve described in JP-A-09-222926 includes a valve housing that has a sliding hole that opens at an outer face of the shutoff valve, a pilot valve element that opens and closes, from below, a valve opening that is formed at a bottom portion of a valve chest that is formed so as to communicate with the lower end of the sliding hole, and a main valve element which slides within the sliding hole and of which the lower end contacts the upper end of the pilot valve element. The upper end of the sliding hole is blocked by a removable diaphragm, and the upper end of the main valve element contacts the diaphragm. A snap ring, of which the outline is larger than the sliding hole, is fitted to the main valve element at a portion that is lower than the sliding hole and that is positioned at the valve chest. The snap ring prevents ejection of the main valve element from the sliding hole due to an internal pressure in the valve chest when the diaphragm is removed.

With the structure described in JP-A-09-222926, ejection of the main valve element is prevented by the snap ring. However, assembly of the shutoff valve is complicated because the main valve element needs to be fitted in the valve housing from the side of the valve chest that is below the sliding hole.

### SUMMARY OF THE INVENTION

A gas shutoff valve according to an aspect of the invention includes a valve element that has a main valve portion that is housed in a valve chest that opens at an outer face of the valve housing and that shuts off a passage for gas when contacting a valve seat formed at a bottom portion of the valve chest, an operation screw portion that is screwed into a female screw portion formed at an opening portion of the valve chest, and a seal portion that is provided between an inner face of the valve chest and an outer face of the main valve portion. The passage is opened or blocked when the main valve portion is moved in the axial direction of the valve element due to rotation of the operation screw portion. A restriction portion is arranged at a position that is apart from the female screw portion by a distance that is shorter than an effective length for the operation screw portion by which the operation screw portion is allowed to travel in such a direction that the operation screw portion is unscrewed along the axial direction of the valve element while being screwed into the female screw portion.

With the structure described above, when the operation screw portion is unscrewed, the valve element contacts the restriction portion before the operation screw portion is completely unscrewed from the valve housing. Therefore, when the operation screw portion is unscrewed, an operator can easily recognize that the valve element has been moved by a sufficient distance in the unscrewing direction. Accordingly, it is possible to reliably avoid the situation where the valve element is excessively unscrewed. As a result, with the simple structure in which the restriction portion is provided outside the valve chest, it is possible to prevent ejection of the valve element due to a pressure in the valve chest.

### BRIEF DESCRIPTION OF THE DRAWINGS

The foregoing and further features and advantages of the invention will become apparent from the following description of an example embodiment with reference to the accompanying drawings, wherein like numerals are used to represent like elements and wherein:

FIG. 1 is a circuit diagram showing a gas tank;

FIG. 2 is a partial cross-sectional view showing a shutoff valve that blocks an opening portion of the gas tank;

FIG. 3 is a cross-sectional view showing the shutoff valve;

FIG. 4 is a cross-sectional view taken along the line A-A in FIG. 3;

FIGS. 5A and 5B are plan views showing an effect of an extending portion;

FIG. 6 is a plan view showing a restriction plate viewed from the side opposite to an operation screw;

FIG. 7 is a cross-sectional view showing the shutoff valve, for describing an effect of the restriction plate;

FIG. 8 is a cross-sectional view showing the shutoff valve, for describing an effect of the restriction plate; and

FIGS. 9A, 9B and 9C are cross-sectional views showing other examples of a restriction member.

### DETAILED DESCRIPTION OF THE EMBODIMENT

Hereafter, an embodiment of the invention will be described with reference to the accompanying drawings. In the embodiment, the invention is applied to a hydrogen gas tank.

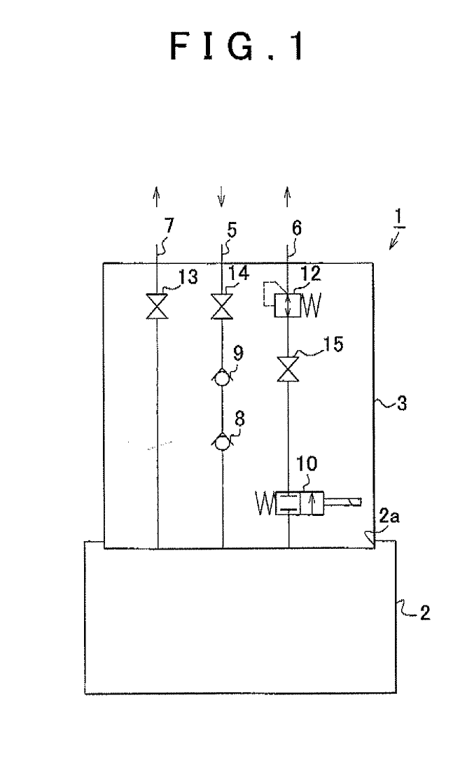

As shown in FIG. 1, a gas tank 1 in the embodiment includes a tank body 2 that stores hydrogen gas having a high pressure (e.g. 70 MPa), and a plug body 3 that blocks an opening portion 2a of the tank body 2. The plug body 3 has a plurality of passages that provide communication between the inside and the outside of the gas tank 1 (tank body 2) and a plurality of valve devices that control gas flows within the passages.

The plug body 3 has a charging passage 5 through which hydrogen gas is charged into the gas tank 1, a supply passage 6 through which the hydrogen gas in the gas tank is supplied to elements outside the gas tank 1, and a release passage 7 through which the hydrogen gas in the gas tank 1 is released to the outside of the gas tank 1.

Two check valves 8 and 9 that prevent backflow of the hydrogen gas stored in the gas tank 1 are provided in the charging passage 5. An electromagnetic on-off valve 10 and a pressure-reducing valve 12 are provided in the supply passage 6. Manual valves 14, 15 and 13 that are externally and manually operated to shut off hydrogen gas flows within the passages are provided in the passages 5, 6 and 7, respectively.

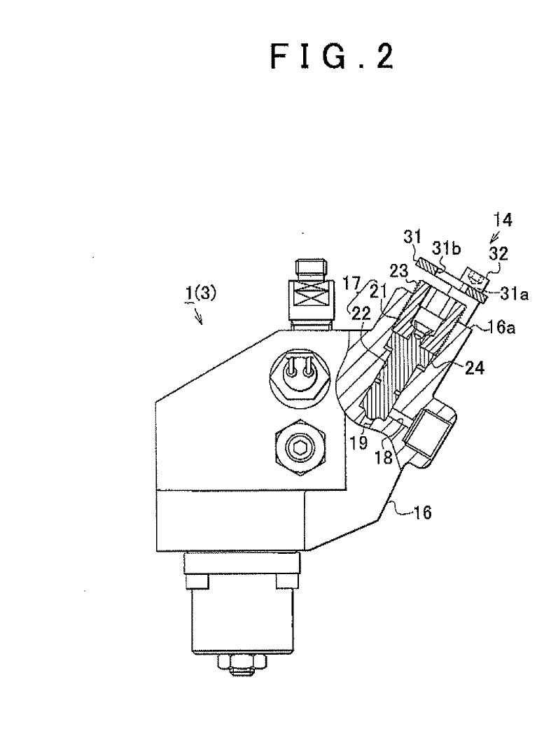

As shown in FIG. 2, in a plug body housing 16 that is used as a valve housing that forms the plug body 3, there is formed a housing recess portion 17 that serves as a valve chest that opens at an outer face 16a of the plug body housing 16. A first passage 18 and a second passage 19 that form the charging passage 5 are communicated with the housing recess portion 17. The manual valve 14 that is arranged in the charging passage 5 is provided in the housing recess portion 17. The manual valves 14, 15 and 13 arranged in the passages 5, 6, and 7, respectively, have the same structure. Only the manual valve 14 arranged in the charging passage 5 will be described below, and description on the other manual valves 13 and 15 will be omitted.

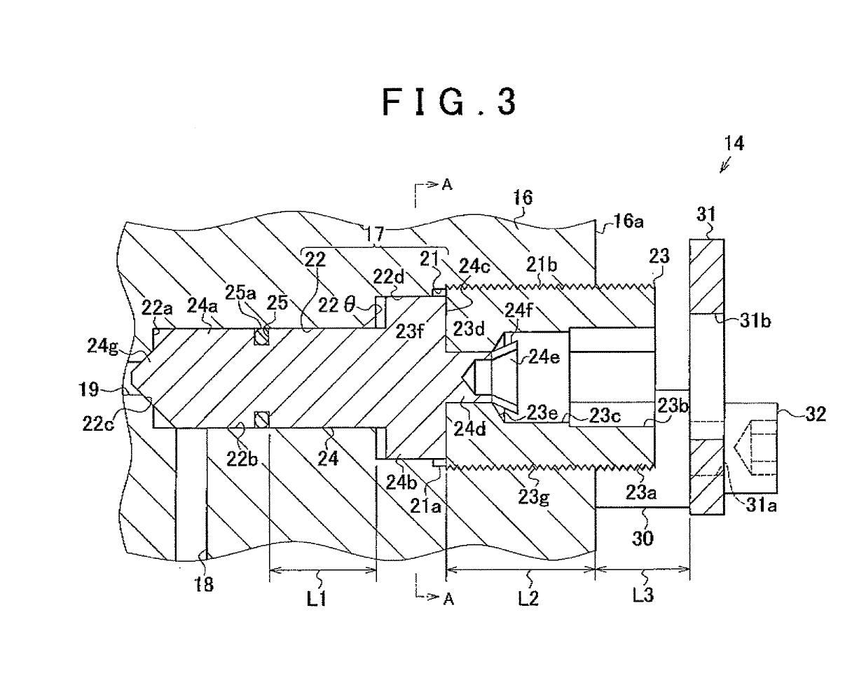

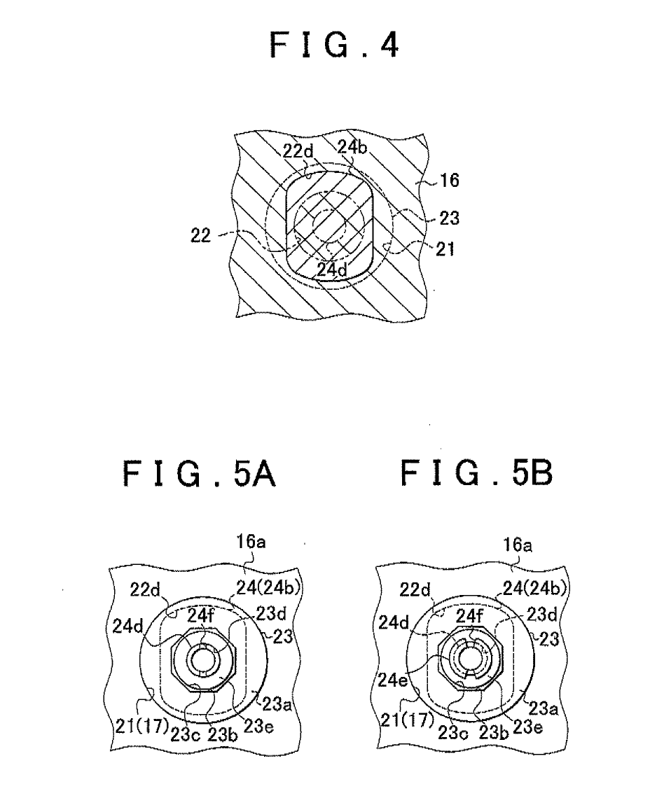

As shown in FIG. 3, the housing recess portion 17 is formed of an operation screw housing portion 21 that opens at the outer face 16a of the plug body housing 16, and a valve element housing portion 22 that is a recess formed in a bottom face 21a of the operation screw housing portion 21. The operation screw housing portion 21 has a circular cross section, and a female screw portion 21b having a thread groove is formed in the inner peripheral face of the operation screw housing portion 21 at a portion close to the opening portion. The first passage 18 that communicates with the outside of the tank opens at a side wall 22b at a portion near a bottom portion 22a of the valve element housing portion 22. The second passage 19 that communicates with the inside of the tank opens at the bottom portion 22a. A valve seat 22c is formed in the bottom portion 22a at a portion around the opening of the second passage 19. The valve element housing portion 22 has a circular cross section having a diameter smaller than that of the operation screw housing portion 21. A housing-side restriction portion 22d that is a large inner-diameter portion having a substantially elliptical cross section is formed at a portion of the valve element housing portion 22, which is close to the operation screw housing portion 21. As shown in FIG. 4, the housing-side restriction portion 22d is larger in the inner diameter than the valve element housing portion 22 in the radial direction (up-down direction in FIG. 4) when viewed in the axial direction. In FIG. 4, the valve element housing portion 22 is indicated by a two-dot chain line.

As shown in FIG. 3, an operation screw 23 that forms a valve element of a shutoff valve is provided in the operation screw housing portion 21. The operation screw 23 is screwed into the female screw portion 21b with a base end portion 23a exposed on the outside of the gas tank 1. A hexagon socket 23b is formed in the base end portion 23a. If a hexagon wrench is inserted into the hexagon socket 23b and the operation screw 23 is rotated by the hexagon wrench, the operation screw 23 is moved in its axial direction. A recess portion 23c having a circular cross section is formed in the bottom face of the hexagon socket 23b, and a through-hole 23d that opens at an end portion of the operation screw 23 is formed in a bottom face 23e of the recess portion 23c. The bottom face 23e is an inclined face. The distance between the bottom face 23e and a main valve element 24 is reduced toward the center of the bottom face 23e.

As shown in FIG. 3, the main valve element 24 that forms the valve element of the shutoff valve is provided in the valve element housing portion 22. The main valve element 24 is arranged in the valve element housing portion 22 so as to be slidable along the axial direction of the main valve element 24. The main valve element 24 includes a main valve portion 24a formed in a substantially column shape, and a rotation restriction portion 24b having a cross-sectional shape different from that of the main valve portion 24a. An annular groove 25 is formed in the outer periphery of the main valve portion 24a, and an O-ring 25a that forms a seal portion is fitted in the groove 25. The rotation restriction portion 24b has a substantially elliptical cross-sectional shape corresponding to the housing-side restriction portion 22d (see FIG. 4), and is arranged at a position corresponding to the housing-side restriction portion 22d when the main valve element 24 is arranged in the valve element housing portion 22. A base end face 24c of the main valve element 24 is in surface-contact with an end face 23f of the operation screw 23.

An extending portion 24d is formed at a substantially center portion of the end face of the rotation restriction portion 24b, which is close to the operation screw 23. The extending portion 24d has a shape of a column having an outer diameter slightly smaller than the inner diameter of the through-hole 23d of the operation screw 23. The extending portion 24d is fitted in the through-hole 23d of the operation screw 23. Plastic deformation portions 24e are provided at the end of the extending portion 24d. In the embodiment, the main valve element 24 and the operation screw 23 are connected to each other by the plastic deformation portions 24e.

As shown in FIG. 5A, before the main valve element 24 and the operation screw 23 are connected to each other, the end of the extending portion 24d is formed in a cylindrical shape and a pair of radially opposed slits 24f is formed at the end of the extending portion 24d. When the main valve element 24 and the operation screw 23 are connected to each other, first, the extending portion 24d of the main valve element 24 is inserted in the through-hole 23d of the operation screw 23 so that the base end face 24c of the main valve element 24 and the end face 23f of the operation screw 23 contact each other (see FIG. 3). At this time, the end of the extending portion 24d projects from the through-hole 23d of the operation screw 23 toward the opposite side of the main valve element 24, that is, inside of the recess portion 23c. Then, a jig, for example, a slotted screwdriver, is inserted in the slits 24f formed at the end of the extending portion 24d from the side of the hexagon socket 23b of the operation screw 23, and portions each having an arc-shaped cross section are expanded outward (lateral direction, in the case in FIG. 5B) so as to be plastically deformed. The plastic deformation portions 24e are engaged with the bottom face 23e of the operation screw 23 in the axial direction of the operation screw 23 in such a manner that the plastic deformation portions 24e are rotatable relative to the operation screw 23. Thus, the main valve element 24 and the operation screw 23 are engaged with each other in the axial direction so as to be rotatable relative to each other. Because a jig, for example, a slotted screwdriver, is inserted in the slits 24f from the side of the hexagon socket 23b and the extending portion 24d is rotated, it is possible to rotate only the main valve element 24 without rotating the operation screw 23. Thus, for example, if the rotation restriction portion 24b of the main valve element 24 is offset from the housing-side restriction portion 22d when the main valve element 24 and the operation screw 23, which have been connected to each other, are inserted in the housing recess portion 17 of the plug body housing 16, the rotation restriction portion 24b of the main valve element 24 is easily aligned with the housing-side restriction portion 22d by the jig that is inserted in the slits 24f from the side of the operation screw 23. Preferably, a slight clearance (e.g. approximately 0.1 mm) is left between each plastic deformation portion 24e of the main valve element 24 and the portion that defines the through-hole 23d of the operation screw 23 (inclined face 23e), and between the base end face 24c of the main valve element 24 and the end face 23f of the operation screw 23, so that relative rotation between the main valve element 24 and the operation screw 23 is not hindered.

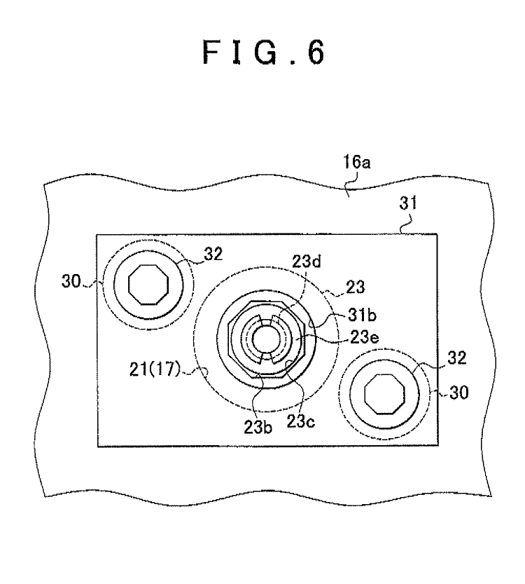

As shown in FIG. 3, one restriction plate 31 is fixed to the outer face 16a of the plug body housing 16 via two spacers 30 (see FIG. 6), In FIG. 3, the spacer 30 that is at a position closer to a reader in the direction perpendicular to the sheet on which FIG. 3 is drawn is omitted. Each spacer 30 is formed in a cylindrical shape, and one restriction plate 31 is fixed to end portions of the spacers 30. Through-holes 31a are formed at portions of the restriction plate 31, which correspond to the spacers 30. In the state where the restriction plate 31 is arranged at the ends of the spacers 30, if bolts 32 are inserted in the through-holes 31a from the outside of the restriction plate 31 and the restriction plate 31 is fastened to the plug body housing 16, the restriction plate 31 is fixed to the plug body housing 16. Displacement of the restriction plate 31 toward the plug body housing 16 is restricted by the spacers 30. That is, the distance between the restriction plate 31 and the outer face 16a of the plug body housing 16 is maintained constant by the spacers 30. As shown in FIG. 6, an operation hole 31b having an inner diameter larger than the outer diameter of the operation screw 23 is formed at a portion of the restriction plate 31, which corresponds to the operation screw 23 when viewed in the axial direction of the operation screw 23. If a hexagon wrench is inserted in the hexagon socket 23b through the operation hole 31b, it is possible to operate the operation screw 23 with the restriction plate 31 fitted to the plug body housing 16.

In the embodiment, in the valve-closed state where an end portion 24g of the main valve element 24 contacts the valve seat 22c, a length L1 of the main valve element 24 at a portion from the groove 25 to a bottom face 22e of the housing-side restriction portion 22d along the axial direction is set to be shorter than a length L2 of a portion of a male screw portion 23g of the operation screw 23, which is screwed into the female screw portion 21b of the plug body housing 16, along the axial direction in the valve closed state. That is, the effective length L1 for the seal portion, that is, the distance that can be traveled by the O-ring 25a of the main valve element 24 with the valve housing portion 22 sealed by the O-ring 25a is set to be shorter than the length L2, that is, the distance that can be traveled by the operation screw 23 while being screwed into the female screw portion 21b. A thickness L3 of each spacer 30 is set to be smaller than the length L2. Therefore, the restriction plate 31 is arranged at a position that is apart from the female screw portion 21b by a distance shorter than the length L2.

The main valve element 24 moves along with the operation screw 23 in the axial direction when the operation screw 23 is rotated. A description will be provided on the assumption that, for example, the operation screw 23, which has been in the valve-closed state shown in FIG. 3, is moved in such a direction that the operation screw 23 is unscrewed from the female screw portion 21b by a rotating operation (hereinafter, referred to as “unscrewing direction”). Because the plastic deformation portions 24e of the main valve element 24 are engaged with the operation screw 23 in the axial direction, the main valve element 24 and the operation screw 23 are movable together with each other in the axial direction. The main valve element 24 moves together with the operation screw 23 in the axial direction, and the end portion 24g of the main valve element 24 moves away from the valve seat 22c. Thus, the hydrogen gas in the first passage 18 flows into the valve element housing portion 22, flows into the second passage 19 that opens at the bottom portion of the valve element housing portion 22, and is then charged into the tank body 2.

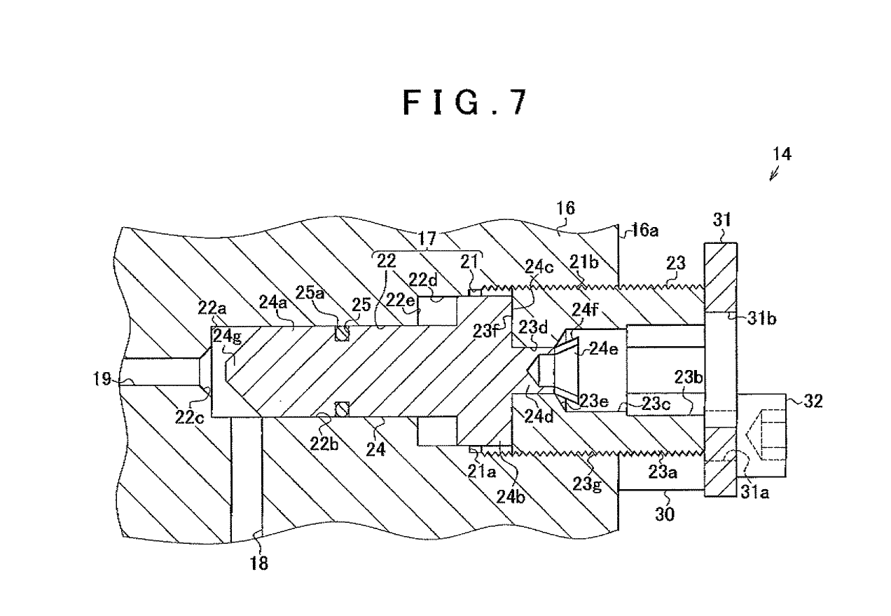

Next, a description will be provided on the assumption that the operation screw 23 is further moved in the unscrewing direction by the rotating operation. As described above, the thickness L3 of the spacer 30 is set to be smaller than the length L2, and the restriction plate 31 is arranged at the position that is apart from the female screw portion 21b by the distance shorter than the length L2. Therefore, as shown in FIG. 7, the operation screw 23 contacts the restriction plate 31 before operation screw 23 is completely unscrewed from the plug body housing 16. Therefore, an operator can easily recognize that the operation screw 23 has been moved by a sufficient distance in the unscrewing direction. Because the operation screw 23 contacts the restriction plate 31, the operation screw 23 is prevented from being excessively unscrewed. Accordingly, it is possible to prevent ejection of the operation screw 23 and the main valve element 24 due to a gas pressure in the valve element housing portion 22.

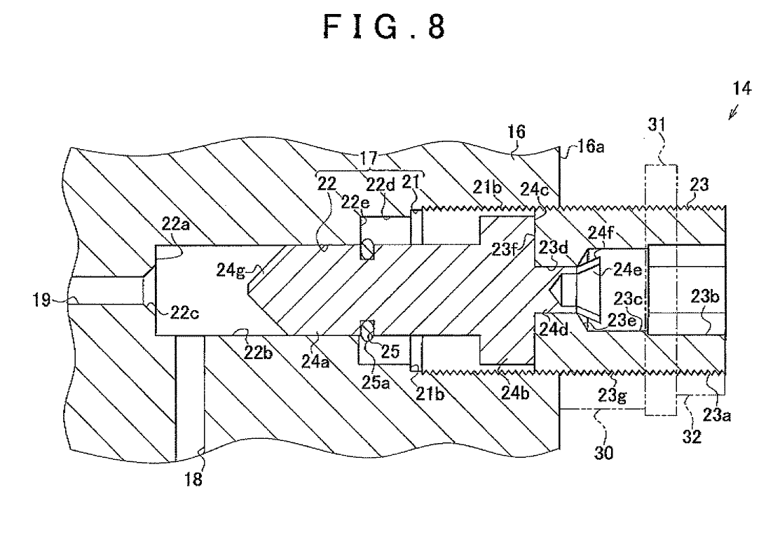

Next, a description will be provided on the assumption that the operation screw 23 is further moved in the unscrewing direction although the operation screw 23 contacts the restriction plate 31. As described above, the length L1 is shorter than the length L2. Therefore, the effective length L1 for the seal portion, that is, the distance that can be traveled by the O-ring 25a interposed between the inner face of the valve element housing portion 22 and the outer face of the main valve element 24 with the valve housing portion 22 sealed by the O-ring 25a is shorter than the length L2. Therefore, as shown in FIG. 8, before the operation screw 23 is completely unscrewed from the plug body housing 16, the O-ring 25a reaches the housing-side restriction portion 22d so that the sealed state provided by the O-ring 25a is cancelled. The hydrogen gas in the valve element housing portion 22 is released to the outside through a clearance between the O-ring 25a and the housing-side restriction portion 22d so that the pressure in the valve element housing portion 22 is reduced. Accordingly, it is possible to prevent ejection of the valve element due to the pressure in the valve element housing portion 22. In FIG. 8, the spacer 30 and the restriction plate 31 are indicated by two-dot chain lines. When the hydrogen gas is released to the outside through the clearance between the O-ring 25a and the housing-side restriction portion 22d, a large gas leak sound is generated. Due to this gas leak sound, the operator can easily recognize that the operation screw 23 has been moved by a sufficient distance in the unscrewing direction.

Next, a description will be provided on the assumption that the operation screw 23, which has been in the valve-open state shown in FIG. 7, is moved in such a direction that the operation screw 23 is further screwed into the female screw portion 21b by a rotating operation (hereinafter, referred to as “screwing direction”). In this case, the main valve element 24 is pushed by the operation screw 23 and moves in the screwing direction. The rotation restriction portion 24b of the main valve element 24 is engaged with the housing-side restriction portion 22d in the circumferential direction so that rotation of the main valve element 24 is restricted. Therefore, it is possible to suppress generation of deformation of the valve seat 22c or the end portion 24g of the main valve element 24 that contacts and moves away from the valve seat 22c. Then, the end portion 24g of the main valve element 24 contacts the valve seat 22c, and the second passage 19 is blocked so that hydrogen gas flow in the charging passage 5 is shut off.

The effects produced in the embodiment will be summarized as below.

1) The restriction plate 31 is arranged at the position that is apart from the female screw portion 21b by the distance shorter than the length L2 of the portion of the male screw portion 23g of the operation screw 23, which is screwed into the female screw portion 21b of the plug body housing 16, along the axial direction in the valve closed state. Therefore, when the operation screw 23 is unscrewed, the operation screw 23 contacts the restriction plate 31 before the operation screw 23 is completely unscrewed from the plug body housing 16. Therefore, when unscrewing the operation screw 23, the operator can easily recognize that the operation screw 23 is moved by a sufficient distance in the unscrewing direction. Therefore, it is possible to reliably prevent the operation screw 23 from being excessively unscrewed. Accordingly, with the simple structure where the restriction plate 31 is provided onto the outer face 16a of the plug body housing 16, it is possible to prevent ejection of the operation screw 23 and the main valve element 24 due to a gas pressure in the valve element housing portion 22. Because the restriction plate 31 is provided outside the plug body housing 16, it is possible to fit the restriction plate 31 to the plug body housing 16 easily.

2) The effective length L1 for the seal portion, that is, the distance that can be traveled by the O-ring 25a of the main valve element 24 with the valve housing portion 22 sealed by the O-ring 25a is set to be shorter than the length L2, that is, the distance that can be traveled by the operation screw 23 while being screwed into the female screw portion 21b. Accordingly, when the operation screw 23 is unscrewed, the O-ring 25a reaches the housing-side restriction portion 22d before the operation screw 23 is completely unscrewed from the plug body housing 16, so that the sealed state provided by the O-ring 25a is cancelled and the pressure in the valve element housing portion 22 is reduced. Therefore, it is possible to avoid the situation where the operation screw 23 and the main valve element 24 are ejected due to the pressure in the valve element housing portion 22 when the operation screw 23 is excessively unscrewed. Also, only adjustment of the effective length L1 for the seal portion and the length L2 that is the effective length for the operation screw 23 is needed. Therefore, the efficiency of fitting the main valve element 24 and the operation screw 23 is not affected. In addition, the operator can easily recognize that the operation screw 23 has been moved by a sufficient distance in the unscrewing direction by a gas leak sound that is generated when the sealed state provided by the O-ring 25a is cancelled.

3) If both the above-described structures 1) and 2) for preventing ejection of the main valve element 24 and the operation screw 23 are adopted, it is possible to more reliably prevent ejection of the main valve element 24 and the operation screw 23. As a result, higher level of safety is ensured.

4) The main valve element 24 and the operation screw 23 are engaged with each other in the axial direction so as to be rotatable relative to each other, if the end of the extending portion 24d that extends inside the operation screw 23 through the through-hole 23d of the operation screw 23 is plastically deformed in the state where the end portion of the main valve element 24, which is on the opposite side of the valve seat 22c, contacts the operation screw 23 in the axial direction. Therefore, the main valve element 24 and the operation screw 23 are movable together with each other in the axial direction. Accordingly, a member used to cause the main valve element 24 and the operation screw 23 to move together with each other need not be provided. As a result, the structure may be simplified.

5) If the rotation restriction portion 24b of the main valve element 24 is engaged with the plug body housing 16, even when a rotational force is applied to the main valve element 24 due to an operation of the operation screw 23, rotation of the main valve element 24 relative to the plug body housing 16 is restricted. Accordingly, it is possible to avoid the situation where deformation is caused in the main valve portion 24a that contacts and moves away from the valve seat 22c and the sealing performance is reduced or abrasion power is generated. Accordingly, the sealing performance for the end portion 24g of the main valve element 24 is ensured. Because the number of components is not increased, the structure is not complicated.

As in the embodiment, when the valve is used as the high-pressure hydrogen gas shutoff valve, if the main valve element 24 is pushed against the operation screw 23 by the pressure of high-pressure gas, a rotational force of the operation screw 23 may be transferred to the main valve element 24. Accordingly, employment of the above-described structure for preventing rotation of the main valve element 24 is effective.

The embodiment described above may be modified as follows.

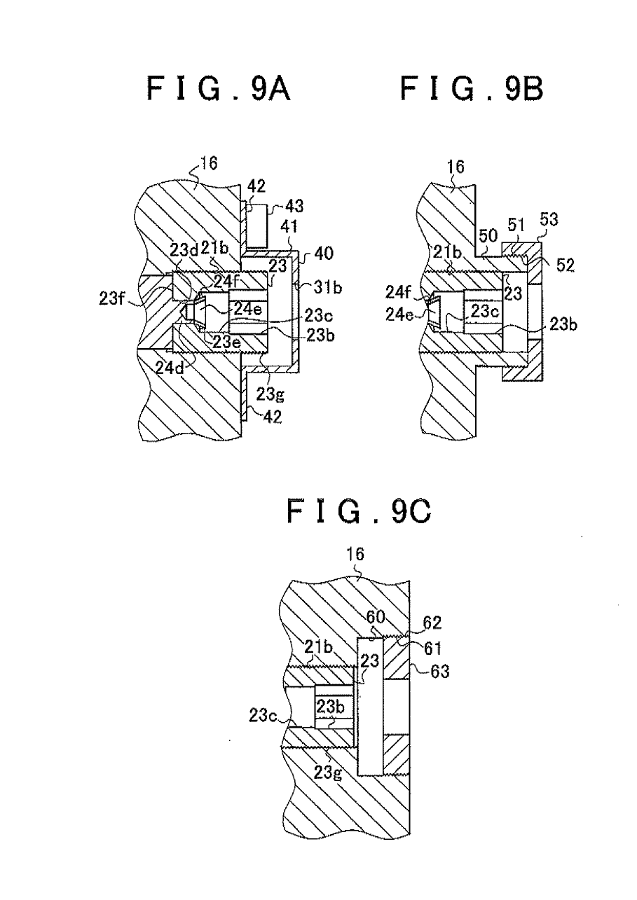

In the embodiment, the flat restriction plate 31 is fixed to the plug body housing 16 via the spacers 30. However, the structure is not limited to this, as long as a restriction member is arranged at a position that is apart from the female screw portion 21b by a distance shorter than the length L2 of the portion of the male screw portion 23g of the operation screw 23, which is screwed into the female screw portion 21b of the plug body housing 16, along the axial direction in the valve closed state. For example, a restriction member 40 shown in FIG. 9A that includes a restriction portion 41 that has a U-shaped cross section and that opens toward the operation screw 23 and fixing flanges 42 that extend outward from the end portion of the restriction portion 41 may be fixed to the plug body housing 16 with a bolt 43. As shown in FIG. 9B, a cylindrical restriction member fixing portion 50 may be provided around the opening portion of the plug body housing 16. Then, a male screw portion 51 may be formed in the end portion of the outer peripheral face of the restriction member fixing portion 50, and a restriction member 53 that has a female screw portion 52, into which the male screw portion 51 is screwed, may be provided. As shown in FIG. 9C, a restriction member fixing recess portion 60 that has an inner diameter larger than the inner diameter of the female screw portion 21b may be formed at a portion of the plug body housing 16, which is close to the opening of the female screw portion 21b. Then, a female screw portion 61 may be formed in an end portion of the inner peripheral face of the restriction member fixing recess portion 60, and a restriction member 63 that has a male screw portion 62 that screws into the female screw portion 61 may be provided. In the embodiment, after the main valve element 24 and the operation screw 23 are housed in the housing recess portion 17, a portion of the female screw portion 21b of the operation screw housing portion 21 may be plastically deformed so that displacement of the operation screw 23 is restricted. In this case, the plastically deformed portion corresponds to the restriction portion. With the structures described above, the number of components may be less than that in the embodiment described above. With the structure shown in FIG. 9C, there is no portion that projects from the outer face 16a of the plug body housing 16. Accordingly, the structure in FIG. 9C is effective especially when the number of portions that project from the outer face 16a needs to be reduced.

In the embodiment described above, the valve element is formed of the main valve element 24 and the operation screw 23. However, the structure of the valve element is not limited to this. A valve element in which a main valve element and an operation screw are integrated together may be used.

In the embodiment described above, the main valve element 24 and the operation screw 23 are directly fitted to the plug body housing 16 that forms the plug body 3. However, the structure is not limited to this. For example, the main valve element 24 and the operation screw 23 fitted to a housing that differs from the plug body housing 16 may be fitted to the plug body housing 16. In this case, the housing different from the plug body housing 16 corresponds to the valve housing in the invention.

In the embodiment described above, the invention is applied to the manually and externally operable shutoff valves (manual valves 13 to 15). However, the invention may be applied to electromagnetically-driven shutoff valves or hydraulically-driven shutoff valves. That is, the invention may be applied to any types of shutoff valves that shut off high-pressure hydrogen gas passage when the main valve element 24 is pushed against the valve seat due to rotation of the operation screw 23.

In the embodiment, the two types of structures for preventing ejection of the main valve element 24 and the operation screw 23 are adopted. However, one of the two types of structures may be omitted. When only the restriction plate 31 is provided as the structure for preventing ejection, the following effects can be obtained. That is, as described above, because the restriction plate 31 is provided outside the plug body housing 16, the restriction plate 31 is easily fitted to the plug body housing 16. Accordingly, it is possible to easily fit the restriction plate 31 to the existing manual valve 14 that does not have any structures for preventing ejection of the main valve element 24 and the operation screw 23.

What is claimed is:

1. A gas shutoff valve, comprising:
a valve housing;
a valve element; and
a restriction portion,
wherein the valve element has
a main valve portion that is housed in a valve chest that opens at an outer face of the valve housing and that shuts off a passage for gas when contacting a valve seat formed at a bottom portion of the valve chest,
an operation screw portion that is screwed into a female screw portion formed at an opening portion of the valve chest, and
a seal portion that is provided between an inner face of the valve chest and an outer face of the main valve portion,
wherein the passage is opened or blocked when the main valve portion is moved in an axial direction of the valve element due to rotation of the operation screw portion, and
wherein the restriction portion is arranged at a position that is apart from the female screw portion by a distance that is shorter than an effective length for the operation screw portion by which the operation screw portion is allowed to travel in such a direction that the operation screw portion is unscrewed along the axial direction of the valve element while being screwed into the female screw portion.

2. The gas shutoff valve according to claim 1,
wherein, in the inner face of the valve chest, between a portion corresponding to the seal portion when the main valve portion contacts the valve seat and a portion in which the female screw portion is formed, there is formed a large inner-diameter portion that has a large inner diameter and that is apart from the seal portion of the valve element,
wherein an effective length for the seal portion by which the seal portion is allowed to travel while sealing the valve chest is set to be shorter than the effective length for the operation screw portion by which the operation screw portion is allowed to travel while being screwed into the female screw portion.

3. The gas shutoff valve according to claim 1, wherein the restriction portion has an opening that passes through the restriction portion in an axial direction of the restriction portion.

4. The gas shutoff valve according to claim 2, wherein the restriction portion has an opening that passes through the restriction portion in an axial direction of the restriction portion.

5. A gas shutoff valve, comprising:
a valve housing; and
a valve element;
wherein the valve element has
a main valve portion that is housed in a valve chest that opens at an outer face of the valve housing and that shuts off a passage for gas when contacting a valve seat formed at a bottom portion of the valve chest,
an operation screw portion that is screwed into a female screw portion formed at an opening portion of the valve chest, and
a seal portion that is provided between an inner face of the valve chest and an outer face of the main valve portion,
wherein the passage is opened or blocked when the main valve portion is moved in an axial direction of the valve element due to rotation of the operation screw portion,
wherein, in the inner face of the valve chest, between a portion corresponding to the seal portion when the main valve portion contacts the valve seat and a portion in which the female screw portion is formed, there is formed a large inner-diameter portion that has a large inner diameter and that is apart from the seal portion of the valve element, and
wherein an effective length for the seal portion by which the seal portion is allowed to travel while sealing the valve chest is set to be shorter than the effective length for the operation screw portion by which the operation screw portion is allowed to travel while being screwed into the female screw portion.

6. The gas shutoff valve according to claim 1, wherein the gas is high-pressure hydrogen gas.

7. The gas shutoff valve according to claim 2, wherein the gas is high-pressure hydrogen gas.

8. The gas shutoff valve according to claim 3, wherein the gas is high-pressure hydrogen gas.

9. The gas shutoff valve according to claim 4, wherein the gas is high-pressure hydrogen gas.

10. The gas shutoff valve according to claim 5, wherein the gas is high-pressure hydrogen gas.
